(19) United States
(12) Patent Application Publication
(10) Pub. No.: US 2009/0294028 A1
(43) Pub. Date: Dec. 3, 2009

(54) PROCESS FOR FABRICATING HIGH DENSITY STORAGE DEVICE WITH HIGH-TEMPERATURE MEDIA

(75) Inventors: John Heck, Berkeley, CA (US); Nickolai Belov, Los Gatos, CA (US); Zebulah Nathan Rapp, Campbell, CA (US); Terry Zhu, Tampa, FL (US)

Correspondence Address: FLIESLER MEYER LLP, 650 CALIFORNIA STREET, 14TH FLOOR, SAN FRANCISCO, CA, 94108, US

(73) Assignee: NANOCHIP, INC., Fremont, CA (US)

(21) Appl. No.: 12/132,139

(22) Filed: Jun. 3, 2008

(51) Int. Cl. B32B 38/10; B32B 38/00; B32B 37/00

(52) U.S. Cl. 156/153

(57) ABSTRACT

A method of fabricating an information storage device comprises providing a media substrate including a first side and a second side, forming a media on the first side of the media substrate, adhesively associating the media with a carrier substrate, thinning a surface of the second side of the media substrate while supporting and protecting the media with the carrier substrate, and forming circuitry on the thinned second side of the media substrate.

### BACKGROUND

Software developers continue to develop steadily more data intensive products, such as ever-more sophisticated, and graphic intensive applications and operating systems. As a result, higher capacity memory, both volatile and non-volatile, has been in persistent demand. Add to this demand the need for capacity for storing data and media files, and the confluence of personal computing and consumer electronics in the form of portable media players (PMPs), personal digital assistants (PDAs), sophisticated mobile phones, and laptop computers, which has placed a premium on compactness and reliability.

Nearly every personal computer and server in use today contains one or more hard disk drives (HDD) for permanently storing frequently accessed data. Every mainframe and supercomputer is connected to hundreds of HDDs. Consumer electronic goods ranging from camcorders to digital data recorders use HDDs. While HDDs store large amounts of data, they consume a great deal of power, require long access times, and require “spin-up” time on power-up. Further, HDD technology based on magnetic recording technology is approaching a physical limitation due to super paramagnetic phenomenon. Data storage devices implemented with micro-electromechanical system (MEMS) and nano-electromechanical system (NEMS) structures including probe tips have been proposed for accessing multiple different media types and applying multiple different read and/or write techniques. Many of the proposed media types are fabricated or otherwise formed by manufacturing processes requiring temperatures undesirably high and/or intolerable for MEMS and NEMS structures, complicating integration of components to fabricate such data storage devices.

### BRIEF DESCRIPTION OF THE DRAWINGS

Further details of the present invention are explained with the help of the attached drawings in which:

FIG. 1 is a cross-sectional side view of an information storage device including a plurality of tips extending from corresponding cantilevers toward a movable media.

FIGS. 2A-2I are cross-sectional process flow diagrams illustrating an embodiment of a method in accordance with the present invention of forming the information storage device of FIG. 1.

### DETAILED DESCRIPTION

Information storage devices enabling potentially higher density storage relative to current ferromagnetic and solid state storage technology can include nanometer-scale heads, contact probe tips, non-contact probe tips, and the like capable of one or both of reading and writing to a media. High density information storage devices can include seek-and-scan probe (SSP) memory devices comprising cantilevers from which probe tips extend for communicating with a media using scanning-probe techniques. The cantilevers and probe tips can be implemented in a MEMS and/or NEMS device with a plurality of read-write channels working in parallel. Probe tips are hereinafter referred to as tips and can comprise structures that communicate with a media in one or more of contact, near contact, and non-contact mode. A tip need not be a protruding structure. For example, in some embodiments, a tip can comprise a cantilever or a portion of the cantilever.

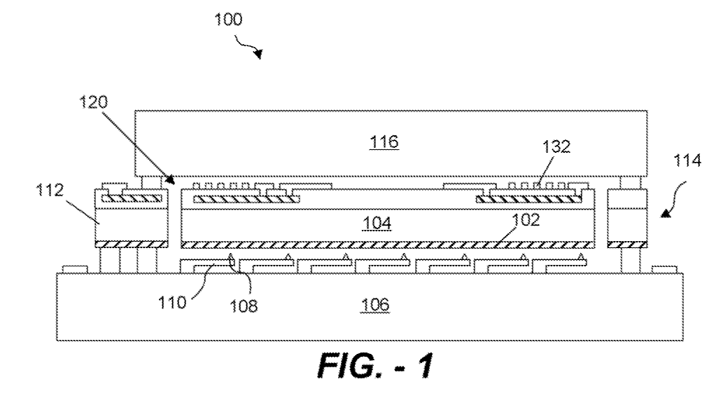

FIG. 1 is a simplified cross-section of an embodiment of a high density storage device 100 comprising a tip substrate 106 arranged substantially parallel to a media 102 disposed on a media platform 104. Cantilevers 110 extend from the tip substrate 106, and tips 108 extend from respective cantilevers 110 toward the surface of the media 102. A recording layer of the media 102 can comprise a chalcogenide material, ferroelectric material, polymeric material, charge-trap material, or some other manipulable material known in probe-storage literature. Embodiments of methods in accordance with the present invention can be applicable to multiple different recording layer materials and information storage techniques; however, methods in accordance with the present invention will be described hereinafter with particular reference to recording layers comprising ferroelectric materials.

The media platform 104 is suspended within a frame 112 by a plurality of suspension structures (e.g., flexures, not shown), with a media substrate 114 comprising the frame 112 and the media platform 104. The media platform 104 can be urged within the frame 112 by way of thermal actuators, piezoelectric actuators, voice coil motors 132, etc. The media substrate 114 can be bonded with the tip substrate 106 and a cap 116 can be bonded with the media substrate 114 to seal the media platform 104 within a cavity 120. The sealing is, preferably, vacuum-proof. Optionally, nitrogen or some other passivation gas, at atmospheric pressure or at some other desired pressure, can be introduced and sealed in the cavity 120.

Crystalline ferroelectric materials may have favorable characteristics compared with one or more of the alternative recording layer options. Ferroelectric materials potentially support high achievable bit densities with satisfactory bit retention, tribology and data transfer rate. Further, mechanisms for reading and writing to a ferroelectric material may support a desired tip and circuit architecture. However, formation of ferroelectric films can require deposition processes performed at undesirably high temperatures (e.g. >600° C.). Many metallic components of the high density storage device of FIG. 1 cannot tolerate the temperatures required for forming ferroelectric films. Embodiments of methods in accordance with the present invention can overcome temperature restriction by enabling fabrication of a recording layer on a media substrate prior to fabrication of complementary circuitry and/or structures.

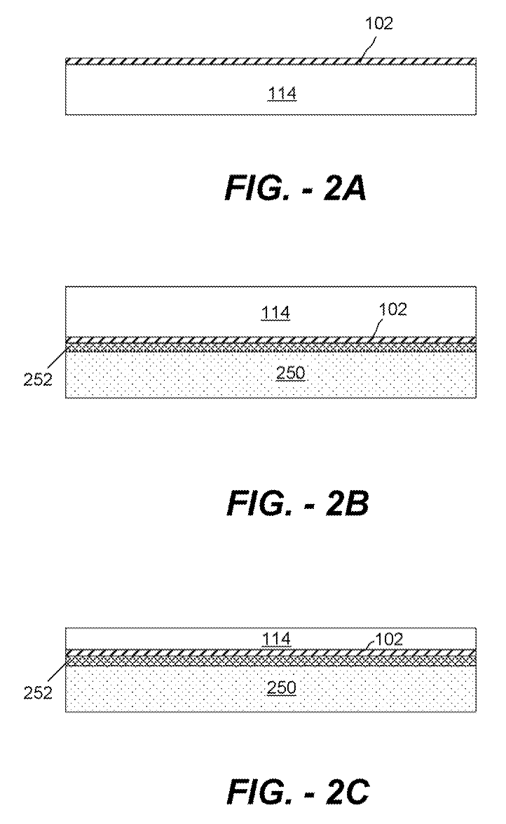

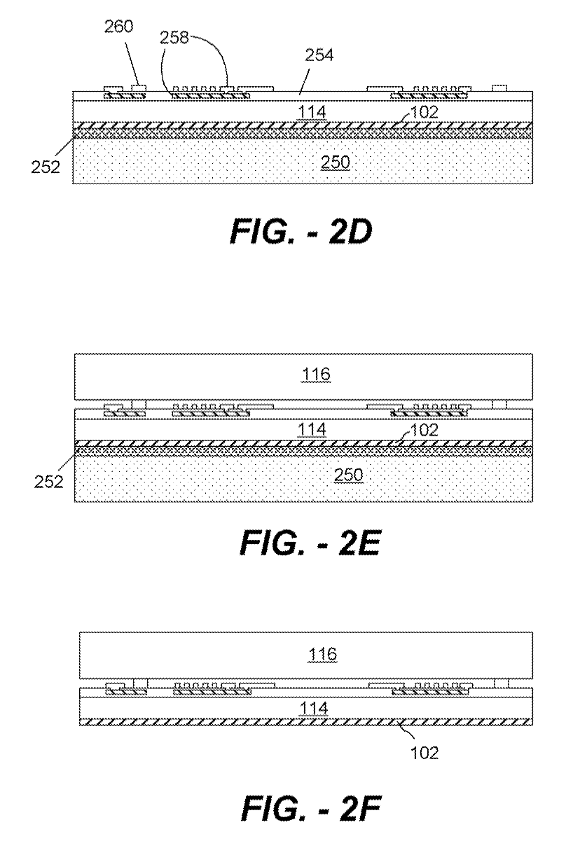

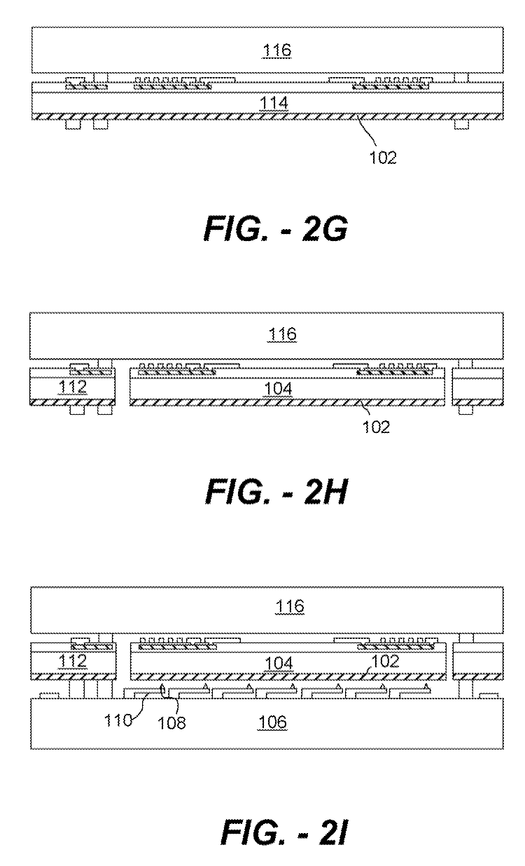

Referring to FIGS. 2A-2I, an embodiment of a method of forming an information storage device in accordance with the present invention is demonstrated by process flow diagrams illustrating progressive manufacturing steps. A media of the information storage device can be fabricated on a wafer comprising one of a standard, single-side polished silicon (Si) wafer or a silicon-on-insulator (SOI) wafer. The wafer provides a substrate 114 for forming the media. Optionally, a profile (not shown) can be created on the media substrate 114 defining standoffs which determine separation between the media substrate 114 and the tip substrate 106 after bonding. The profile can be created by one or more fabrication techniques selected from dry etching of the media substrate, wet etching of the media substrate, and deposition and patterning of additional material. Additional material for forming standoffs can include (but are not limited to) thermally grown silicon dioxide (thermal oxide), plasma-enhanced chemical vapor deposited (PECVD) oxide, PECVD nitride, PECVD oxynitride, chemical vapor deposited (CVD) silicon carbide, low-pressure chemical vapor deposited (LPCVD) nitride.

Referring to FIG. 2A, a media 102 is deposited or formed on the media substrate 114 by way of an appropriate fabrication technique, or by a series of fabrication techniques independent of temperature constraints of cantilever, tip and metallized structures. For example, a process for forming a ferroelectric film can include depositing a film by sputtering a target having a stoichiometric composition of a ferroelectric compound or combination of ferroelectric compounds, implanting the ferroelectric film with one or more ferroelectric constituents to render the ferroelectric film stoichiometric, CVD deposition of ferroelectric material and annealing the ferroelectric film at high temperature (e.g., 600° C.) to form a crystalline ferroelectric film. The media can comprise more than one film (i.e., the media can comprise a film stack). For example, the media can comprise a conductive film formed between the ferroelectric film and the substrate to provide a bottom electrode, and an adhesion/intermediate layer formed between the bottom electrode and the substrate. For example, a film stack of strontium titanate (STO), strontium ruthenate (SRO), and ferroelectric layer of lead zirconate titanate (PZT) can be used as a memory media stack (or media). The series of fabrication techniques can include patterning the media, while patterning can be selectively performed on layers of a film stack. The top PZT layer can be patterned to expose the SRO layer in some areas, both PZT and SRO layers can be removed in some other areas and the entire film stack (STO-SRO-PZT) can be removed in some other areas. Fabrication techniques can further include deposition and patterning of at least some layers of a bonding stack provided for wafer-level bonding with a tip substrate in subsequent processing. For example, an interlayer comprising one or both of a dielectric and a seed metal layer can be deposited on the media substrate before bonding the media substrate to a temporary carrier substrate. Alternatively, an adhesion metal layer can be deposited and patterned before bonding the media substrate to the temporary carrier substrate. Still further, the fabrication techniques can provide a protective layer, such as a polymer layer, dielectric layer, semiconductor layer, metal layer, or combination of two or more protective layers for protection of a film stack in subsequent processing.

Referring to FIG. 2B, the media substrate 114 is mounted to a temporary carrier substrate 250 so that the surface of the media 102 opposes the surface of the temporary carrier substrate 250. The media substrate 114 can be mounted using an adhesion layer 252, which may comprise one or more of a polymeric material (e.g., acrylate, silicone), a thermoplastic material, a thermally decomposing polymer (e.g., poly-norbornene), a material losing adhesive properties as a result of exposure to radiation, and a wax material, or alternatively some other suitable material. An appropriate adhesion layer 252 can be selected based on a chosen de-bonding process. The temporary carrier substrate 250 can comprise myriad different materials as well. For example, the temporary carrier substrate 250 can comprise silicon (i.e., the temporary carrier substrate can be a silicon wafer). Alternatively, if a selected de-bonding process includes exposure to radiation, the temporary carrier substrate 250 can comprise silicon dioxide (i.e., the temporary carrier substrate can be a glass wafer) or some other transparent, or semi-transparent material. Referring to FIG. 2C, a surface of the media substrate 114 opposite the temporary carrier substrate 250, is thinned by grinding, polishing, etching, or a combination thereof. If the media substrate comprises SOI, initial material thinning of the media substrate 114 can be stopped on the buried oxide layer. Thus, for example, in an embodiment the media substrate 114 can be thinned to 150-300 μm so that a movable media platform (104, shown in FIG. 1) formed during subsequent processing exhibits desired mechanical characteristics.

Referring to FIG. 2D, dielectric layer(s) 254 and metal layers 258 are formed on the exposed side of the media substrate 114, distal from the media 102. The dielectric and metal layers are sequentially formed, patterned and etched to provide electrical circuitry, including signal routing traces, actuation structures such as coils suitable for use in electromagnetic actuation, and position sensing structures such as capacitive sensor plates. Further, a solder layer 260 can be formed suitable for substrate bonding. Optionally, stand-offs (not shown) can be formed to maintain separation between a cap (116, in FIG. 2E) and the media substrate 114. The dielectric and metal layers should be formed at a sufficiently low temperature (e.g., <250° C.) so as not to damage or catastrophically weaken the adhesion layer 252 bonding the media substrate 114 and the temporary carrier substrate 250. Dielectric materials that may be used include low-temperature oxides, nitrides, or oxynitrides deposited by CVD, polymer dielectrics such as polyimide with a low curing temperature, organic/inorganic materials such as spin-on-glass (SOG), or similar materials. Micromachining of the media substrate 114 can also be performed, for example to define portions of suspension structures such as flexures connecting a media platform 104 with a media frame 112. Optionally, cavities and trenches can be etched within the media platform area in order to reduce its mass.

Structures fabricated on both sides of the media substrate 114 are aligned to each other. Alignment can be achieved by aligning the first layer processed on the exposed media substrate 114 (after thinning), distal from the media 102 with a reference pattern on the media side of the media substrate 114. Alignment can be achieved using different techniques. In a preferred embodiment, infrared (IR) alignment can be performed. Alternatively, where an optically transparent temporary carrier substrate and temporary bonding layer is used optical double-side alignment can be performed. Tools for IR and optical double-side alignment are well known in the art.

Referring to FIG. 2E, a cap 116 is bonded to the media substrate 114. Bonding is performed within the tolerable thermal budget of the temporary carrier substrate 250 and the adhesion layer 252 between the temporary carrier substrate 250 and the media substrate 114, forming a bond capable of withstanding temperatures of subsequent bonding of the tip substrate (106 in FIG. 1) with the media substrate 114. For example, bonding by way of a layer of gold (Au) and a layer of indium (In) can be accomplished at 160 . . . 170° C. as In melted at 156° C. Allowing the In to diffuse into the Au results in formation of a Au—In composition having a reflow temperature of 400° C. or higher. Alternatively, tin (Sn) layer and either Au or Cu layer can be used for bonding. Bonding can be achieved at 250° C. as Sn melting temperature is 232° C. As a result of bonding Sn can diffuse into the Au or Cu to form a Au—Sn composition or Cu—Sn composition, which can withstand without melting much higher temperatures than the bonding temperature, In still another approach bonding can be achieved by using a AuSn layer and Au layer. Bonding can be achieved at 300° C., as Au and Sn form an 80 Au/20 Sn eutectic at approximately 280° C. Allowing additional Au to diffuse into the Au—Sn composition during bonding can raise the melting temperature of final alloy, allowing the bond to withstand exposure to temperatures higher than the bonding temperature in later processing. Preferably, an intermetallic composition or an alloy is formed during bonding process by liquifying at least one component participating in the alloy formation and the liquification occurs at a temperature lower than the melting temperature of the alloy formed as a result of the bonding process. For example, Cu—Sn alloy can be formed by forming Cu bonding layer on one substrate and forming at least Sn bonding layer on the other substrate, bringing the bonding layers in contact and heating up the substrates above melting temperature of Sn. As a result of rapid interdiffusion of Cu and Sn a bonding layer is formed. The bonding layer contains Cu—Sn alloy, which has a melting temperature significantly higher than the bonding temperature.

Referring to FIG. 2F, when the cap 116 is bonded to the media substrate 114, the temporary carrier substrate 250 can be removed. De-bonding of the temporary carrier substrate 250 and the media substrate 114 can be accomplished using any technique or combination of techniques that is non-destructive to the media substrate 114 and cap 116 stack (i.e., the workpiece). For example, de-bonding can be accomplished by peeling, thermal decomposition, and ultraviolet (UV) or infra-red (IR) light-assisted decomposition or degradation of the adhesive (including by laser ablation). Alternatively, de-bonding can be accomplished by heating at or near a reflow temperature of the adhesion layer 252 and sliding or “wedging” the temporary carrier substrate 250 and workpiece.

Referring to FIG. 2G, after de-bonding of the temporary carrier substrate has been accomplished additional processing can be performed on the media substrate. The additional processing can include deposition and patterning of a bond layer, wherein the bond layer can comprise a suitable material such as Au, Cu, Sn, In, Au—Sn composition or combination of these materials as described above. Further, if standoffs have not been defined on the surface of the media substrate, standoffs can be formed to maintain a gap between the media and tip substrate (not shown).

Referring to FIG. 2H, deep reactive ion etching (RIE) is performed to “release” the media platform 104, allowing the media platform 104 to move in-plane within a media frame 112, suspended from the media frame 112 by flexures (not shown). Pad expose grooves (not shown) in the media substrate 114 can be etched to allow sawing through the media substrate to expose bond pads on the tip substrate following bonding while reducing a risk of damaging bond pads on the tip substrate during such sawing.

Referring to FIG. 21, the tip substrate 106 (processed separately) is bonded to the workpiece. Bonding can be accomplished using similar techniques as described above, i.e., by forming a bond layer comprising a Au—In, Cu—Sn or Au—Sn compositions. Alternatively, bonding can be accomplished using any suitable wafer bonding technique, such as by forming a bond layer comprising a Au—Si eutectic, or Au-germanium (Ge) eutectic, or alternatively by Au thermocompression. After bonding, the workpiece now comprising the bonded tip substrate, media substrate, and cap is sawed and/or etched to expose the bond pads on the media substrate and the tip substrate.

As can be seen from the above description, the invented process allows fabrication of high density data storage devices such as seek-and-scan probe memory with media materials deposited at high temperatures without limiting the ability to form required electrical and mechanical components of the device in the media substrate.

The foregoing description of the present invention has been presented for purposes of illustration and description. It is not intended to be exhaustive or to limit the invention to the precise forms disclosed. Many modifications and variations will be apparent to practitioners skilled in this art. The embodiments were chosen and described in order to best explain the principles of the invention and its practical application, thereby enabling others skilled in the art to understand the invention for various embodiments and with various modifications as are suited to the particular use contemplated. It is intended that the scope of the invention be defined by the following claims and their equivalents.

1. A method of fabricating an information storage device comprising:
providing a media substrate including a first side and a second side;
forming a media on the first side of the media substrate;
adhesively associating the media with a carrier substrate;
thinning a surface of the second side of the media substrate while supporting and protecting the media with the carrier substrate; and
forming circuitry on the thinned second side of the media substrate.

2. The method of claim 1, further comprising:
bonding a cap to the thinned second side of the media substrate; and
disassociating the media substrate from the carrier substrate.

3. The method of claim 2, further comprising:
defining a movable platform in the media substrate for urging a portion of the media; and
bonding the media substrate to a tip substrate so that the movable platform is arranged between the cap and the tip substrate.

4. The method of claim 3, further comprising:
exposing bond pads of the media substrate electrically connected with the circuitry; and
exposing bond pads of the tip substrate electrically connected with the tip substrate.

5. The method of claim 1, wherein forming the media on a media substrate further comprises:
forming a media stack including one or more layers of strontium titanate, strontium ruthenate and lead zirconate titanate.

6. The method of claim 5, wherein forming the media on a media substrate further comprises:
patterning one or more layers of the media stack.

7. The method of claim 1, wherein forming the media on a media substrate further comprises defining stand-offs capable of spacing the media from a parallel surface arranged in opposition of the media.

8. The method of claim 1, wherein adhesively associating the media with a carrier substrate includes reversibly bonding the media to the carrier substrate using an adhesive selected from one or more of a polymeric material, a thermoplastic material, and wax.

9. The method of claim 1, wherein thinning a surface of the second side of the media substrate includes one or more of grinding, polishing, and etching.

10. The method of claim 1,
wherein forming circuitry on the thinned second side of the media substrate includes forming and patterning a conductive material on the thinned surface; and
wherein the circuitry includes components chosen from a set of: signal routing traces, one or more capacitive sensor plates, and one or more electromagnetic motor traces.

11. The method of claim 2, wherein the cap is bonded to the thinned second side of the media substrate by forming an alloy.

12. The method of claim 3, wherein the media substrate is bonded to the tip substrate by forming an alloy having a melting temperature.

13. The method of claim 12, wherein the alloy is formed during bonding process by liquifying at least one component participating in the alloy formation and the liquification occurs at a temperature lower than the melting temperature of the alloy formed as a result of the bonding process.

14. The method of claim 12, wherein the alloy is one of a gold-indium alloy, a gold-tin alloy, a copper-tin alloy, a gold-silicon alloy, and a gold-germanium alloy.

15. The method of claim 3, wherein defining a movable platform in the media and the media substrate for urging a portion of the media includes patterning and etching the media and the media substrate to define suspension structures connected between a portion of the media and the media substrate and an outer frame of the media and media substrate within which the portion is suspended.

16. The method of claim 1, wherein the circuitry is formed on the thinned surface at a temperature lower than a melting temperature of an adhesion layer between the media and the carrier substrate.

17. A method of fabricating an information storage device comprising:
providing a first substrate having two sides, side one and opposite side two.
laying out a movable platform and a frame in a first substrate so that the movable platform is nested within the frame;
forming a media on the side one of the first substrate;
removably bonding the side one of the first substrate with a second substrate;
thinning a surface of the side two of the first substrate while supporting the media with the second substrate; and
forming circuitry on the thinned surface of the first substrate;
bonding a third substrate to a portion of the thinned surface of the first substrate associated with the frame;
disassociating the media from the second substrate.
forming the movable platform within the first substrate for urging a portion of the media; and
bonding the frame of the first substrate from side one to a fourth substrate including a plurality of tips so that the movable platform is accessible to tips and arranged between the third substrate and the fourth substrate.

18. The method of claim 17, wherein forming the media on a first substrate further comprises:
forming a media stack including one or more layers of strontium titanate, strontium ruthenate and lead zirconate titanate.

19. The method of claim 18, wherein forming the media on a first substrate further comprises:
patterning one or more layers of the media stack.

20. The method of claim 17, wherein the third substrate is bonded to the portion of the thinned surface of the first substrate by forming an alloy having a melting temperature and wherein the fourth substrate is bonded to the frame of the first substrate at a temperature lower than the melting temperature of the alloy.
